(19) United States
(12) Patent Application Publication
(10) Pub. No.: US 2012/0110478 A1
(43) Pub. Date: May 3, 2012

(54) SYSTEM AND METHOD FOR SUPPORTING SOFTWARE

(75) Inventors: Won Hyuk CHOI, Daejeon (KR); Ki Heon Kim, Daejeon (KR); Won Young Kim, Daejeon (KR); Sung Jin Hur, Daejeon (KR)

(73) Assignee: Electronics and Telecommunications Research Institute, Daejeon (KR)

(21) Appl. No.: 13/270,434

(22) Filed: Oct. 11, 2011

(30) Foreign Application Priority Data
Oct. 27, 2010 (KR) 10-2010-0105254

(51) Int. Cl. G06F 3/048

(52) U.S. Cl. 715/757; 715/764

(57) ABSTRACT

Provided are a software service supporting system and method to a plurality of clients using a software virtualization technology in a server-based computing environment. The present invention is configured to allow a server to execute software selected by a request of a client by using a resource of a client in a virtual environment, extract a GUI, a 3D graphic-intensive work, etc., as results according to software execution, and transmit the extracted result values to the client. Since the virtualization is implemented according to the driving of the software, the present invention can accommodate a larger number of clients at higher speed than the existing server-based computing and save the service introduction costs.

### CROSS-REFERENCE TO RELATED APPLICATIONS

This application claims priority to and the benefit of Korean Patent Application No. 10-2010-0105254 filed in the Korean Intellectual Property Office on Oct. 27, 2010, the entire contents of which are incorporated herein by reference.

### BACKGROUND OF THE INVENTION

1. Field of the Invention

The present invention relates to a software service supporting system and a method, and more particularly, to a software service supporting system and method to a plurality of clients using a software virtualization technology in a server-based computing environment.

2. Description of the Related Art

Recently, in accordance with the development of technologies for manufacturing hardware such as a central processing unit (CPU), a memory, and the like, inexpensive high-performance personal computers (PCs) have rapidly propagated. In addition, the computing capability of the PC has been currently improved to the level of an initial supercomputer. The demand for desktop software (SW) capable of accommodating multi-functional user interfaces and a graphic-intensive work has been increased. Further, graphic hardware technologies have been applied to an existing graphic-intensive work such as 2D/3D, multimedia, as well as have been expansively applied to web browser rendering, flash, Windows operating systems.

A server-based computing environment is a scheme for solving problems such as data security, management cost of a PC, and the like, occurring in a PC-based computing environment. As technologies supporting the server-based computing environment, there are a terminal service based on XenDesktop available from Citrix, VDI available from VMWare, remote desktop protocol (RDP) available from Microsoft, and the like.

However, in the server-based computing, a service executes SW and client PCs only serves as a terminal, such that a load of the server is increased in accordance with the increase of the number of the client. In addition, the server-based computing uses a scheme of transferring result images executed in the server to the client PC, thereby having a limitation in processing a high-performance graphic work such as 3D rendering. Accordingly, it has disadvantages such as the waste of high-specification client PC resources, service limitation according to the load of the server, excessive server purchase cost, slow service performance, and the like.

Further, in the server-based computing, one server supports a plurality of users through a session management technology dependent on OS, and in a desktop service, one server supports a plurality of users through a virtual machine. These technologies have limitations in introduction cost and management of the server due to dependence of the server on OS or a load of the virtual machine.

### SUMMARY OF THE INVENTION

The present invention has been made in an effort to provide a software supporting system and method capable of executing SW in a server and executing a graphic work in a client, by providing SW-level virtualization of an separation execution SW in order to provide a server-based online software service to a plurality of clients.

An exemplary embodiment of the present invention provides a software supporting system, including: a software execution unit executing requested software in an independent virtual environment for each user; a graphic information extractor extracting graphic information associated with graphic processing from executed software; and a software execution controller controlling a second device to process the extracted graphic information and a first device to process the remaining information other than the extracted graphic information.

The first device may provide the software supporting service and is a software supporting server including the software execution unit, the graphic information extractor, and the software execution controller and the second device is a client terminal communicating with the software supporting server. The software support system may further include a graphic information transmitter transmitting the extracted graphic information to the second device and the second device processes the graphic information received through an embedded graphic information processor.

The software execution unit may include: a setting information storage determination unit determining whether or not the software setting information requested for each user is stored by using the user information; a virtual environment information processor extracting the virtual environment information of the software requested in the setting information if it is determined that the setting information is stored and extracting the virtual environment information based on the requested basic setting of the software if it is determined that the setting information is not stored; and a request software execution unit executing the software requested in the independent virtual environment for each user in consideration of the extracted virtual environment information. When the virtual environment independent from the resources of the software supporting server providing the software supporting service is obtained, the request software execution unit includes an input and output signal processor executing the requested software by processing the input and output signal without generating side effects to other software sharing the resources, when the input and output signal for resources generated by the execution-requested software is processed.

The software supporting system may further include a virtual environment generator included in the software supporting server providing the software supporting service and generating the virtual environment independent from the resources of the server for each user.

Another exemplary embodiment of the present invention provides a software supporting method, including: a software executing step executing requested software in an independent virtual environment for each user; a graphic information extracting step extracting graphic information associated with graphic processing from executed software; and a software execution controlling step controlling a second device to process the extracted graphic information and a first device to process the remaining information other than the extracted graphic information.

The first device may provide the software supporting service and is a software supporting server sequentially implementing the software executing step, the graphic information extracting step, and the software execution controlling step and the second device is a client terminal communicating with the software supporting server, wherein the software execution controlling step may further includes a step of transmitting the extracted graphic information to the second device. The software supporting method may further include a graphic information processing step to allow the second device to process the graphic information received through the embedded graphic information processor.

The software execution step may include: a setting information storage determining step determining whether or not the software setting information requested for each user is stored by using the user information; a virtual environment information processing step extracting the virtual environment information of the software requested in the setting information if it is determined that the setting information is stored and extracting the virtual environment information based on the requested basic setting of the software if it is determined that the setting information is not stored; and a request software executing step executing the software requested in the independent virtual environment for each user in consideration of the extracted virtual environment information. When the virtual environment independent from the resources of the software supporting server providing the software supporting service is obtained, the request software execution step executes the requested software by processing the input and output signal without generating side effects to other software sharing the resources, when the input and output signal for resources generating the requested software is processed.

The software supporting method may further include a virtual environment generating step generating a virtual environment independent from resources of the software resource server providing the software supporting service for each user.

As set forth above, the present invention can obtain the following effect by executing SW in the server and executing the graphic work in a client, by providing the SW-level virtualization of the separation execution SW in order to provide the server-based online SW service to the plurality of clients. First, since the actually driven SW is virtualized under the virtual execution environment, the present invention can accommodate a larger number of users and save the initial service introducing cost. Second, in applications frequently using the graphic unit (GPU) such as the 3D rendering, since the graphic unit of the client is used in the case of the separation execution, the present invention shares the graphic unit to process a larger number of clients at higher speed than the server-based computing. Third, the present invention can display graphics capable of maximally exerting the performance of the client graphic unit as compared to simply displaying the result images already performed by the server. Fourth, the present invention uses the separation execution technology, thereby making it possible to display only the screen of the corresponding separation execution SW.

### BRIEF DESCRIPTION OF THE DRAWINGS

FIG. 1 is a block diagram schematically showing a software supporting system according to an exemplary embodiment of the present invention;

FIG. 2 is a block diagram showing a detailed configuration of each component configuring the software supporting system;

FIG. 3 is a conceptual diagram of a server-based SW service supporting a plurality of client users according to the exemplary embodiment;

FIG. 4 is an architectural diagram of separation execution SW driven using a virtual execution environment dependent on server resources according to the exemplary embodiment;

FIG. 5 is a diagram showing a detailed exemplary embodiment of a method in which the separation execution SW is executed in a server; and

FIG. 6 is a diagram showing a detailed exemplary embodiment of a method in which the separation execution SW is executed in a server to be displayed to a client.

### DETAILED DESCRIPTION OF THE EMBODIMENTS

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the exemplary embodiment of the present invention will be described, but it will be understood to those skilled in the art that the spirit and scope of the present invention are not limited thereto and various modifications and changes can be made.

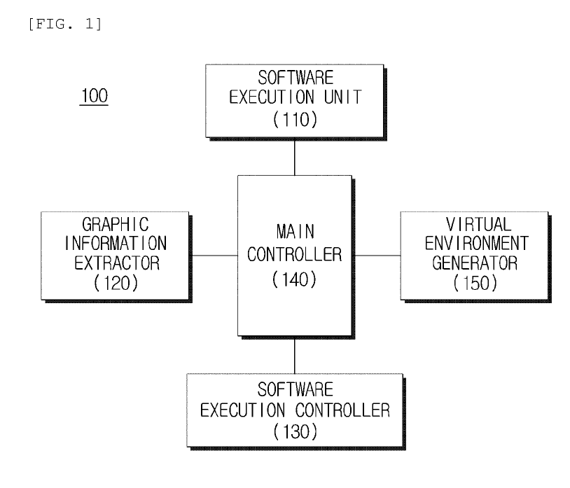

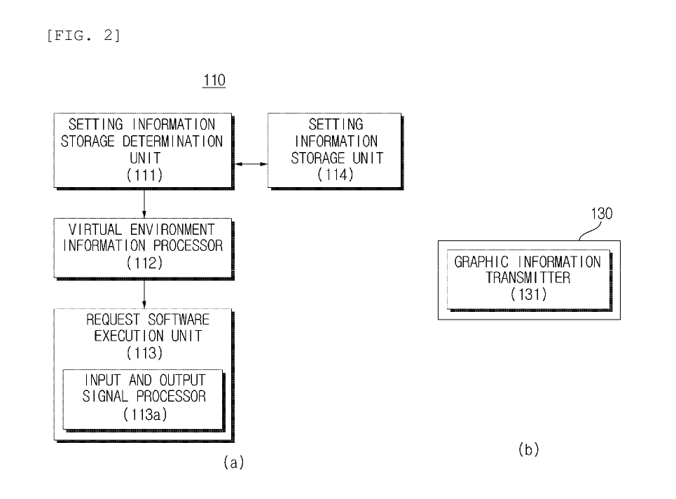

FIG. 1 is a block diagram schematically showing a software supporting system according to an exemplary embodiment of the present invention. FIG. 2 is a block diagram showing a detailed configuration of each component configuring the software supporting system. As shown in FIG. 1, a software supporting system 100 is configured to include a software execution unit 110, a graphic information extractor 120, a software execution controller 130, and a main controller 140.

The exemplary embodiment considers a system load when providing a software supporting service to process a general data-intensive work by setting a virtual environment using server resources and then providing a software supporting service in the virtual environment and process a service requiring high performance such as a graphic work using client resources (for example, a graphic processing unit of a client).

The software execution unit 110 executes required software in independent virtual environments for each user. In the exemplary embodiment, the software execution unit 110 is configured to include a setting information storage determination unit 111, a virtual environment information processor 112, and a required software execution unit 113, as shown in FIG. 2A.

The setting information storage determination unit 111 determines whether or not the setting information of required software is stored for each user using user information. The virtual environment information processor 112 extracts virtual environment information of the required software from the setting information if the setting information is stored, and extracts the virtual environment information based on basic setting of the required software if the setting information is not stored.

The requested software execution unit 113 executes the requested software in independent virtual environments for each user in consideration of the extracted virtual environment information.

When considering the case of obtaining the virtual environment independent on resources of a software supporting server providing the software supporting service, the required software executing unit 113 may include an input/output signal processor 113a. When processing input/output signals for resources which the software required to be executed generates, the input/output signal processor 113a processes the input/output signals not to generate a side effect on other software sharing the resources, thereby executing the required software.

Meanwhile, the exemplary embodiment may further include a setting information storage unit 114 in consideration of the above configuration of the requested software execution unit 110. The setting information storage unit 114 stores setting information of the software including the virtual environment information for executing the software.

The graphic information extractor 120 extracts graphic information associated with graphic processing from the executed software.

The software execution controller 130 controls a second device to process the extracted graphic information and controls a first device to process information except the extracted graphic information.

In the exemplary embodiment, the software execution unit 110, the graphic information extractor 120, and the software execution controller 130 may be provided in the software supporting server supporting the software service. At this time, the first device means the software supporting server, and the second device means a client terminal connected to the server.

The software execution controller 130 may include a graphic information transmitter 131, as shown in FIG. 2B. The graphic information transmitter 131 transmits the extracted graphic information to the second device.

A process processed by the software supporting server is, for example, a data-intensive work, and a process processed by the client terminal is, for example, a graphic-intensive work such as 3D rendering. In this case, the client terminal processes the received graphic information through an embedded graphic information processor.

The software supporting system 100 may further include a virtual environment generator 150 generating a virtual environment used when executing the software. The virtual environment generator 150, which is provided in the software supporting server providing the software supporting service, generates the virtual environments independent on the resource of the software supporting server for each user.

Next, a software supporting system according an exemplary embodiment of the present invention will be described in consideration of actual implementation.

A software supporting system according to an exemplary embodiment of the present invention, which is a system supporting a plurality of users in an online SW service environment, supports virtualization in application program process unit for providing a plurality of SW services to a plurality of client user in providing desktop SW as a service from a server in the online network environment. Hereinafter, a method of providing a server serving a plurality of SW by a plurality of users using a SW virtual execution environment supporting SW-level virtualization in providing a server-based online SW service will be described. In addition, a method of reducing a load concentrated on a server and providing security for user data processed and managed in a client through a SW separation execution method of executing graphic-intensive works such as 3D rendering in the client and processing data-intensive works in the server will be described.

A method of providing a plurality of separation execution SWs to a plurality of users in a sever-based online SW service may be summarized as follows. First, in a first step, the client requests the server to execute the separation execution SW. Then, in a second step, the server recovers previously stored setting information of the SW required to be executed through a user management module, and executes the separation execution SW in virtual execution environments independent on the corresponding server resources using the recovered setting information.

The function is performed by the software execution unit 110 of FIG. 1. In this case, an example of the corresponding server resources may include files, registries, other resources, or the like. Thereafter, in a third step, the server extracts the graphic-intensive work such as the graphic user interface of the executed separation execution SW or the 3D rendering in order transmit it to the corresponding user client. The function is performed by the graphic information extractor 120 of FIG. 1. Then, in a fourth step, the server compresses and encrypts the graphic work and transmits it to the client. The function is performed by the graphic information transmitter 131 of FIG. 2. Thereafter, in a fifth step, the client releases the compressed and encrypted graphic work transmitted from the server and executes and displays it using client's GPU.

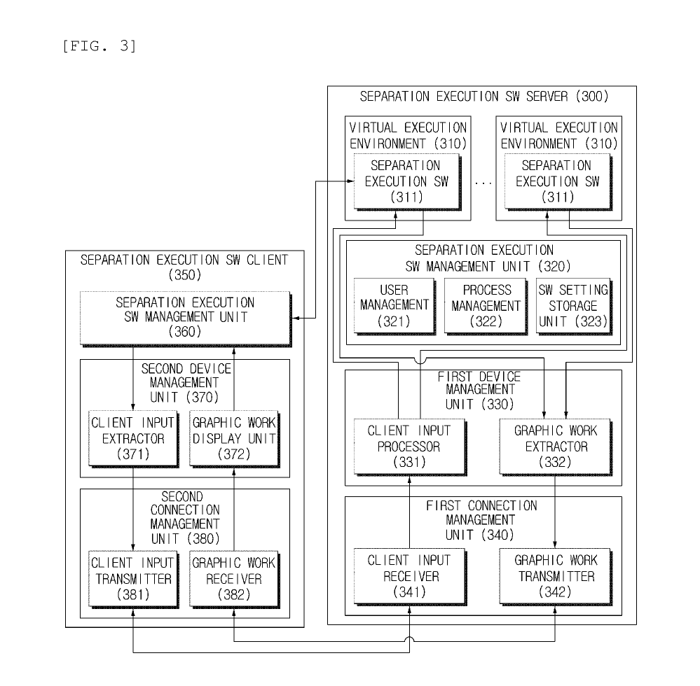

FIG. 3 is a conceptual diagram of a separation execution device of a server-based SW service supporting a plurality of client users. The SW service by the separation execution is classified into a separation execution SW server 300 and a separation execution SW client 350.

The separation execution SW server 300 includes a separation execution SW management unit 320, a first device management unit 330, a first connection management unit 340, etc. The separation execution SW management unit 320 receives a request of a client to manage the execution and ending of the separation execution SW. In FIG. 1, the function is performed by the software execution unit 110. The separation execution SW management unit 320 includes a user management module 321, a process management module 322, an SW setting storage unit 323, etc. The user management module 321 is to manage a plurality of users. The process management module 322 tracks and manages the driven separation execution SW process. The SW setting storage unit 323 stores the final setting information of the SW used for each user. The first device management unit 330 includes a graphic work extractor 332 and a client input processor 331. The graphic work extractor 332 extracts the graphic work of the separation execution SW to be transmitted to the client. The function is performed by the graphic information extractor 120 of FIG. 1. The client input processor 331 processes an input transmitted from the client. The first connection management unit 340 includes a graphic work transmitter 342 and a client input receiver 341. The graphic work transmitter 342 transmits the graphic work of the separation execution SW to the client. The function is performed by the graphic information transmitter 131 of FIG. 2. The client input receiver 341 receives the input information transmitted by the client.

The separation execution SW server 350 includes a separation execution SW management unit 360, a second device management unit 370, a second connection management unit 380, etc. The separation execution SW management unit 360 requests the execution of the separation execution SW of the server. The second device management unit 370 includes a client input extractor 371 and a graphic work display unit 372. The client input extractor 371 extracts the input information such as a keyboard, a mouse, etc. generated from a client. The graphic work display unit 372 processes the graphic work received from the server using client's GPU and displays it on the screen. The second connection management unit 380 includes a client input transmitter 381 and a graphic work receiver 382. The client input transmitter 381 transmits the user input to the server. The graphic work receiver 382 receives the graphic work transmitted from the server.

Meanwhile, the separation execution SW 311 is executed in the server 310, but the execution result and the user interface are displayed to the client 350 by the separation execution SW management unit 360. Therefore, in the execution of the separation execution SW, the graphics processing unit (GPU) of the server is not used and only the graphics processing unit (GPU) of the client is used.

In order for the separation execution server to service the separation execution SW requested by the plurality of users, there is a need to drive the separation execution SW 311 in the virtual execution environment 310 independent from the system resource, not the SW installed in the separation execution server system. The exemplary embodiment can independently apply and execute the SW setting information changing specifications of the user by using the SW setting storage unit 323 and the process management module 322 of the SW management unit 320. The function is performed by the virtual environment information processor 112 of FIG. 2. Further, the graphic work extractor 332 of the first device management unit 330 uses the information of the user management module 321 and the process management module 322 of the separation execution management unit 320 to extract the graphic work information of the separation execution SW 311 execution-requested by the user of the specific separation execution client 350 and transmit it to the corresponding client. Similarly, the user input transmitted from the separation execution client 350 may be appropriately transmitted to the separation execution SW 311 driven in the virtual execution environment 310. As a result, the exemplary embodiment provides the environment in which the plurality of users can use the same SW.

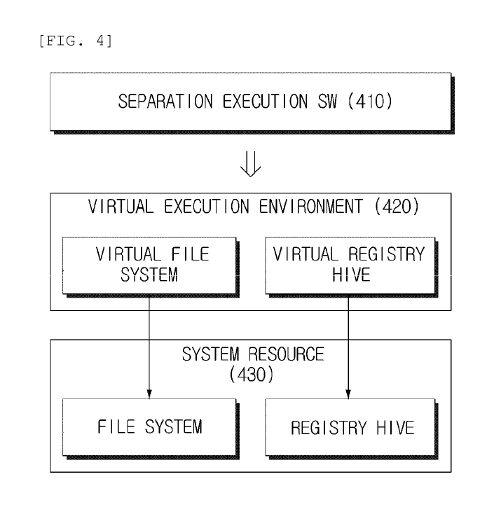

FIG. 4 is an architectural diagram of separation execution SW driven using a virtual execution environment independent on server resources. The virtual execution environment 420 uses a portion of the system resource 430 of the separation execution server to provide the virtual environment in which the separation execution SW 410 is driven independent from the system resource 430. When the separation execution SW 410 is operated, the I/O for various system resources 430 is generated. The virtual execution environment 420 appropriately processes resources based on the generated resource I/O to drive the SW without generating side effect to various SWs sharing the system resource 430. In FIG. 2, the function is performed by the input and output signal processor 113b of the request software execution unit 113. Further, the setting of the separation execution SW used by the user can be consecutively used by using the information of the SW setting storage unit stored for each user. As a result, when the plurality of separation execution client users use the same separation execution SW, they can use the separation execution SW without having an effect on the inherent setting of the client and the SW operational state.

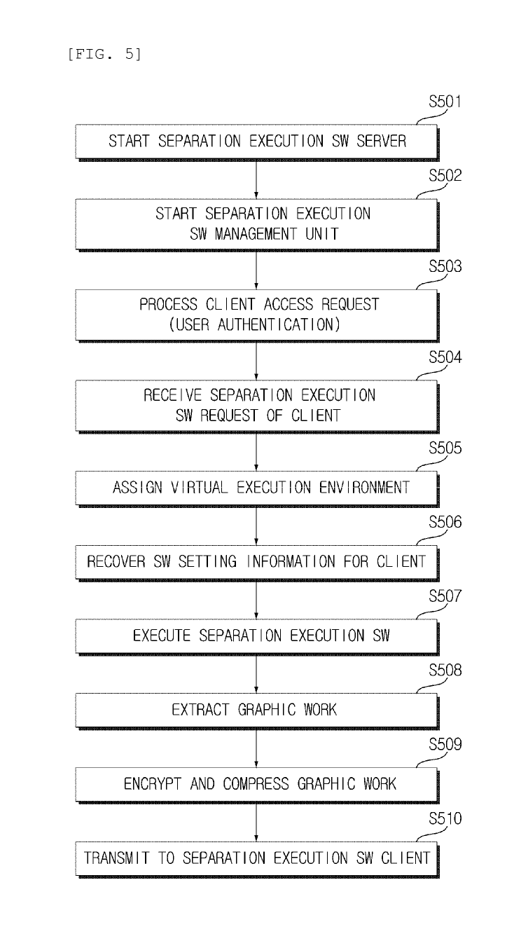

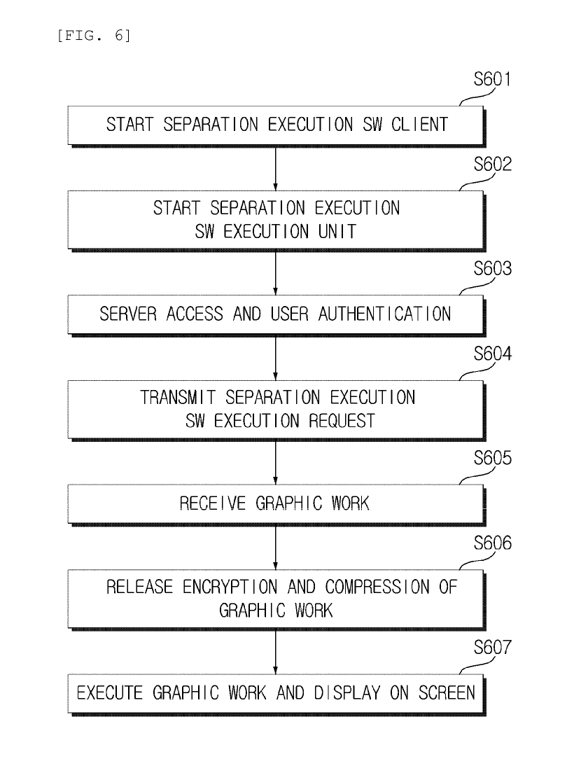

FIGS. 5 and 6 are flow charts showing in detail the software supporting method according to the exemplary embodiment of the present invention. In detail, FIG. 5 shows a detailed exemplary embodiment of the method by which the separation execution SW is executed in the server. In detail, FIG. 6 shows a detailed exemplary embodiment of the method by which the separation execution SW is executed in the server and displayed to the client. The following description will be described with reference to FIGS. 5 and 6.

Referring to FIG. 5, when the separation execution SW server is operated (S501) and the separation execution SW management unit starts (S502), the access of the separation execution client is requested (S503) and may be processed through the appropriate user authentication process. For the separation execution SW execution request (S504) of the accessed separation execution client 350, the separation execution SW management unit checks the resources of the separation execution server system and assigns the virtual execution environment (S505). Thereafter, the SW setting information of the corresponding user is recovered from the SW setting storage unit (S506) and the separation execution SW is executed under the virtual execution environment (S507). The process information of the executed separation execution SW is stored in the process management unit of the separation execution SW management unit. The executed separation execution SW is not displayed on the server screen and the graphic work information for each separation execution SW execution-requested by the client is extracted by the graphic work extractor (S508). The extracted information is compressed and encrypted in order to be transmitted to the client (S509) and is transmitted to the specific separation execution SW client execution-requested by the graphic work transmitter (S510). In addition, when the separation execution SW ending request is input from the separation execution SW client, the final setting information used by the separation execution SW is stored in the SW setting storage unit, releases the system resources assigned for virtual execution environment, and ends the separation execution SW.

Referring to FIG. 6, when the separation execution SW client is operated (S601) and the separation execution SW execution unit starts (S602), it brings the usable separation execution SW list by accessing to the separation execution SW management unit of the separation execution SW server (S603). When the user selects the separation execution SW, the separation execution SW execution request is transmitted to the server (S604). The process of the server for processing the request will be described with reference to FIG. 5. When the graphic work transmitted from the server is received in the graphic work receiver (S605) and the encryption and compression of the corresponding information is released (S606), the graphic work display unit displays the user interface and the graphic work of the separation execution SW executed in the server to the client (S607).

The present invention can be applied to the plurality of users in the online network environment when supporting the software service.

The spirit of the present invention has been just exemplified. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A software supporting system, comprising:
a software execution unit executing requested software in an independent virtual environment for each user;
a graphic information extractor extracting graphic information associated with graphic processing from executed software; and
a software execution controller controlling a second device to process the extracted graphic information and a first device to process the remaining information other than the extracted graphic information.

2. The system of claim 1, wherein the first device provides the software supporting service and is a software supporting server including the software execution unit, the graphic information extractor, and the software execution controller and the second device is a client terminal communicating with the software supporting server.

3. The system of claim 1, wherein the software execution unit includes:
a setting information storage determination unit determining whether or not the software setting information requested for each user is stored by using the user information;
a virtual environment information processor extracting the virtual environment information of the software requested in the setting information if it is determined that the setting information is stored and extracting the virtual environment information based on the requested basic setting of the software if it is determined that the setting information is not stored; and
a request software execution unit executing the software requested in the independent virtual environment for each user in consideration of the extracted virtual environment information.

4. The system of claim 2, further comprising a graphic information transmitter transmitting the extracted graphic information to the second device,
wherein the second device processes the graphic information received through the embedded graphic information processor.

5. The system of claim 1, further comprising a virtual environment generator included in the software supporting server providing the software supporting service and generating the virtual environment independent from the resources of the server for each user.

6. The system of claim 3, wherein when the virtual environment independent from the resources of the software supporting server providing the software supporting service is obtained, the request software execution unit includes an input and output signal processor executing the requested software by processing the input and output signal without generating side effects to other software sharing the resources, when the input and output signal for resources generated by the requested software is processed.

7. A software supporting method, comprising:
a software executing step executing requested software in an independent virtual environment for each user;
a graphic information extracting step extracting graphic information associated with graphic processing from executed software; and
a software execution controlling step controlling a second device to process the extracted graphic information and a first device to process the remaining information other than the extracted graphic information.

8. The method of claim 7, wherein the first device provides the software supporting service and is a software supporting server sequentially implementing the software executing step, the graphic information extracting step, and the software execution controlling step and the second device is a client terminal communicating with the software supporting server, and wherein the software execution controlling step further includes a step of transmitting the extracted graphic information to the second device.

9. The method of claim 7, wherein the software execution step includes:
a setting information storage determining step determining whether or not the software setting information requested for each user is stored by using the user information;
a virtual environment information processing step extracting the virtual environment information of the software requested in the setting information if it is determined that the setting information is stored and extracting the virtual environment information based on the requested basic setting of the software if it is determined that the setting information is not stored; and
a request software executing step executing the software requested in the independent virtual environment for each user in consideration of the extracted virtual environment information.

10. The method of claim 8, further comprising a graphic information processing step processing graphic information received through the embedded graphic information processor by the second device.

11. The method of claim 7, further comprising a virtual environment generating step generating a virtual environment independent from resources of the software resource server providing the software supporting service for each user.

12. The method of claim 9, wherein when the virtual environment independent from the resources of the software supporting server providing the software supporting service is obtained, the request software execution step executes the requested software by processing the input and output signal without generating side effects to other software sharing the resources, when the input and output signal for resources generating the requested software is processed.
